(19) United States
(12) Patent Application Publication
(10) Pub. No.: US 2022/0104460 A1
(43) Pub. Date: Apr. 7, 2022

(54) ANIMAL HARNESS AND INTERCHANGEABLE COVERS AND ACCESSORIES

(71) Applicant: Go Waggish, LLC, Annapolis, MD (US)

(72) Inventors: Holly Berlin, Annapolis, MD (US); Melissa Kay, Columbia, MD (US)

(73) Assignee: Go Waggish, LLC, Annapolis, MD (US)

(21) Appl. No.: 17/490,868

(22) Filed: Sep. 30, 2021

Related U.S. Application Data
(60) Provisional application No. 63/086,457, filed on Oct. 1, 2020.

(51) Int. Cl. A01K 27/00

(52) U.S. Cl. CPC A01K 27/002; A01K 27/005

(57) ABSTRACT

A cover and a harness can combine to form a covered harness for an animal. A harness can comprise a chest strap comprising first and second chest strap portions. A girth strap can comprise a first and second girth strap portion. A harness panel can be connected to the first and second chest strap portion and the first and second girth strap portion. A first and second magnetic element can be embedded under the first and second girth strap portion. A cover can comprise a back wall sheet shaped to cover the harness panel, a top sheet shaped to cover the back wall sheet, and a binding piece securing the back wall sheet and the top sheet. A first and second cover magnetic element can be secured between the top sheet and the back wall sheet and can magnetically connect to the first and second magnetic element.

### FIELD

This application provides an animal harness, interchangeable covers for an animal harness, and accessories compatible therewith.

### BACKGROUND

Animal harnesses need to be secure against the animal to enable control or guidance. However, many harnesses include articles that are dangerous to the animal, such as Velcro that can ensnare carpet, fabrics, plants, thornbushes, the animal's fur, among other examples. Clasps and other hardware, pockets, and handles are additional articles that can endanger the animal. Articles that hang off of or protrude from the harness or come to the edge of the harness, in addition to providing an ensnarement risk, also pose a choking risk should the animal chew on the article. In some examples, articles cover most if not all of the exterior of the harness or are applied diffusely to the exterior in a disadvantageous way.

In addition, many harnesses require complete removal to reconfigure the accessories. For example, a work animal, like a seeing eye dog or rescue dog must change into a new harness to change designations that are sewn or otherwise permanently fixed to the harness. Prior art examples of interchangeable covers require several threading or lacing steps that make it cumbersome to reconfigure the exterior.

Examples of the prior art harnesses can be seen in U.S. Pat. Nos. 10,736,305, 10,517,270, 8,627,788, 8,408,730, & GB 2464471.

### SUMMARY

The methods and devices disclosed herein overcome the above disadvantages and improves the art by way of interchangeable covers, harnesses, and accessories. The ensnarement of the animal in its environment is limited. The ability to ingest parts of the harness is limited. And, exchanging accessories applied to the harness is quick and does not require removal of the harness to exchange the look and functionality of the harness. Changes can be made quickly during walks, training, in response to weather, etc.

A harness for an animal can comprise a chest strap configured to seat near or between a chest and a foreleg area of the animal, the chest strap comprising a first chest strap portion and a second chest strap portion. A girth strap can be configured to wrap around an abdomen of the animal, the girth strap comprising a first girth strap portion and a second girth strap portion. A harness panel can be connected to the first chest strap portion, the second chest strap portion, the first girth strap portion, and the second girth strap portion. A first magnetic element can be embedded under the first girth strap portion. A second magnetic element can be embedded under the second girth strap portion.

A third magnetic element can be embedded under or adjacent the first chest strap portion and a fourth magnetic element can be embedded under or adjacent the second chest strap portion.

One or more of the first magnetic element, the second magnetic element, the third magnetic element, and the fourth magnetic element can be enclosed in a respective tabbed structure and can be secured to the harness panel by way of the respective tabbed structure.

When included, one or more of the first magnetic element, the second magnetic element, the third magnetic element, and the fourth magnetic element can be flush against an exterior of a top layer of the harness panel.

When included, one or more of the first magnetic element, the second magnetic element, the third magnetic element, and the fourth magnetic element can be enclosed between a top layer and a bottom layer of the harness panel.

The harness panel can comprise a top layer, a bottom layer, and a trim piece. When included, the first magnetic element, the second magnetic element, the third magnetic element, and the fourth magnetic element can be enclosed in a respective tabbed structure. At least one or all of the first magnetic element, the second magnetic element, the third magnetic element, and the fourth magnetic element can be joined together with the top layer, the bottom layer, and the trim piece by the respective tabbed structure.

A mid-line handle can be attached to the harness panel. The mid-line handle can be configured to parallel a spine of the animal.

The first girth strap portion can encapsulate the first magnetic element, and whereby the first magnetic element is attached to the harness panel.

The first chest strap portion can encapsulate the first magnetic element, and whereby the encapsulated first magnetic element is attached to the harness panel.

The harness panel can further comprise a trim piece encircling a perimeter of the harness panel, and wherein the trim piece does not overlap with the first magnetic element or the second magnetic element.

A cover for an animal harness can comprise a back wall sheet shaped to cover the harness panel. A top sheet can be shaped to cover the back wall sheet. A binding piece can secure the back wall sheet and the top sheet to form a perimeter cover edge. A first cover magnetic element can be secured between the top sheet and the back wall sheet. A second cover magnetic element can be secured between the top sheet and the back wall sheet.

The first cover magnetic element can be encapsulated in a tabbed structure, and wherein the first cover magnetic element can be secured in place by stitching the tabbed structure together with a portion of the top sheet, and a portion of the back wall sheet.

The tabbed structure can be further stitched together with a portion of the binding piece.

The first cover magnetic element can be encapsulated in a tabbed structure, and wherein the first cover magnetic element can be secured in place by stitching the tabbed structure to the top sheet.

The first cover magnetic element can be configured so that it does not overlap with the binding piece.

The first cover magnetic element can be encapsulated in a tabbed structure, and wherein the cover comprises an inner layer between the back wall sheet and the top sheet, and wherein the first cover magnetic element can be secured to the inner layer.

The cover can comprise a middle portion comprising a leash ring pass-through, the leash ring pass-through passing through the top sheet and through the back wall sheet.

The cover can comprise a girth strap cover configured to overlay the girth strap and at least one chest strap extension configured to overlay a portion of the chest strap.

The first cover magnetic element and the second cover magnetic element can be configured to secure at a shoulder area of the animal or a girth area of the animal.

The cover can be configured to seat under a mid-line handle of the harness, the mid-line handle configured to parallel a spine of the animal.

A covered harness for an animal can comprise a harness, comprising a chest strap, a girth strap, and a harness panel. The chest strap can be configured to seat near or between a chest and a foreleg area of the animal, the chest strap comprising a first chest strap portion and a second chest strap portion. The girth strap can be configured to wrap around an abdomen of the animal, the girth strap comprising a first girth strap portion and a second girth strap portion. The harness panel can be connected to the first chest strap portion, the second chest strap portion, the first girth strap portion, and the second girth strap portion. A first magnetic element can be embedded under the first girth strap portion and a second magnetic element can be embedded under the second girth strap portion. A cover can comprise a back wall sheet shaped to cover the harness panel and a top sheet shaped to cover the back wall sheet. A binding piece can secure the back wall sheet and the top sheet to form a perimeter cover edge. A first cover magnetic element can be secured between the top sheet and the back wall sheet, wherein the first cover magnetic element magnetically connects to the first magnetic element. A second cover magnetic element can be secured between the top sheet and the back wall sheet, wherein the second cover magnetic element magnetically connects to the second magnetic element.

The covered harness can further comprise a third magnetic element embedded under or adjacent the first chest strap portion and a fourth magnetic element embedded under or adjacent the second chest strap portion. A third cover magnetic element can be secured between the top sheet and the back wall sheet, wherein the third cover magnetic element magnetically connects to the third magnetic element. A fourth cover magnetic element can be secured between the top sheet and the back wall sheet, wherein the fourth cover magnetic element magnetically connects to the fourth magnetic element.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

### BRIEF DESCRIPTION OF THE DRAWINGS

FIGS. 1A & 1B are views of alternative harnesses on an animal.

FIG. 2A is a view of a girth expander for a harness.

FIG. 2B is a view of a harness.

FIG. 2C is a view of an alternative chest strap section for a harness.

FIGS. 3A-3C show alternative magnetic element configurations for a harness.

FIG. 4 is a view of a cover.

FIG. 5 is a view of a magnetic element configuration for a cover.

FIG. 6 is a view of a cover comprising jacket features.

### DETAILED DESCRIPTION

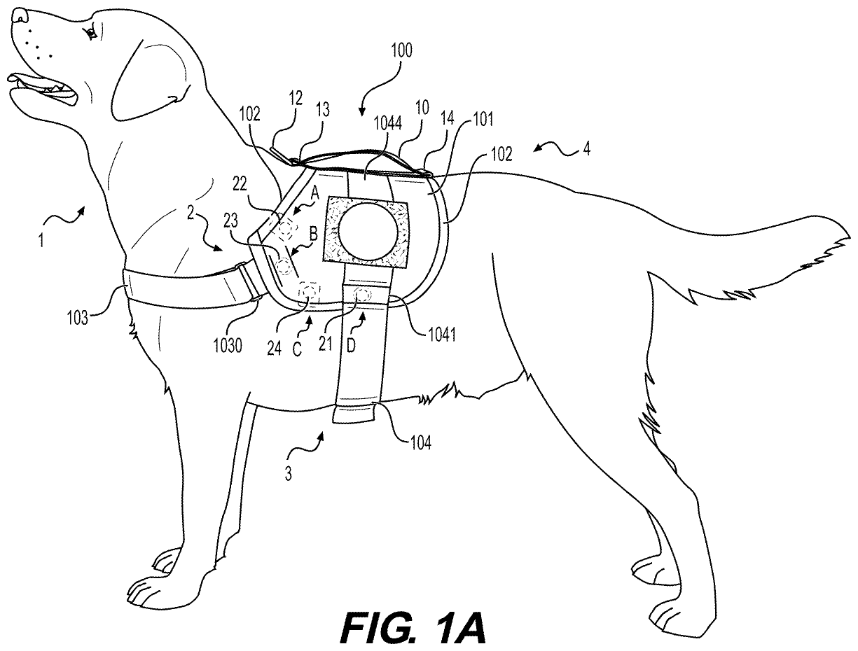

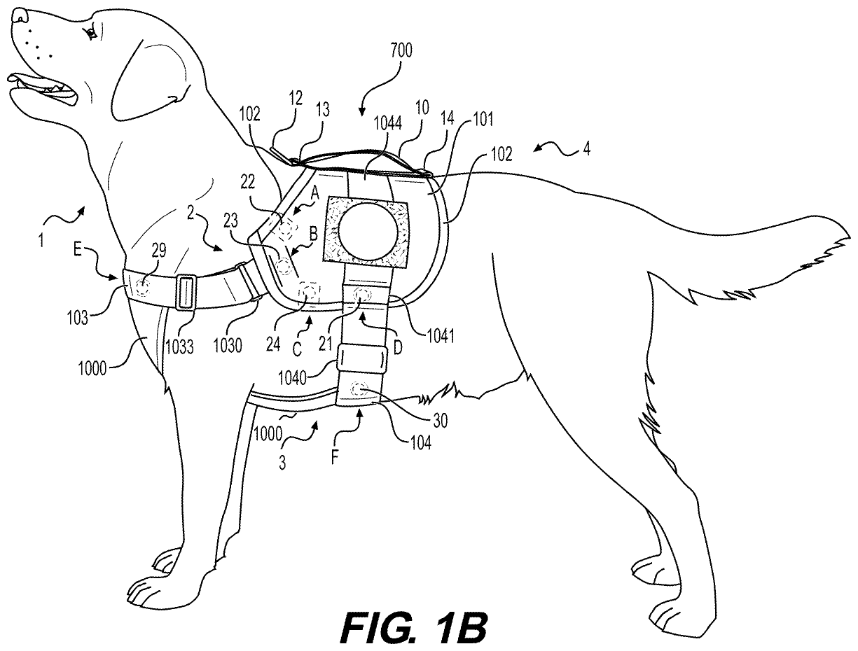

The harness 100, 700 can be used for many animals 1 and the harness 100, 700 is shown on a dog in FIGS. 1A & 1B. Alternative animals 1 can be cats, pigs, ferrets, horses, among others. The harness 100, 700 includes several features outlined in FIGS. 1A-3C. The features can improve, for example, handling, comfort, adjustability, and ease of use, while the cover 500 provides the ability to change the color, pattern, utility and visibility. The harness 100, 700 is designed for ease when putting the harness 100, 700 on and taking the harness 100, 700 off. Its design is easy to understand for product placement and installation. Unlike other harnesses in the prior art, harness 100 requires only a single fastener 1040 when placing the harness 100 on the animal 1 as opposed to other products that require the animal 1 to step in or out or to endure multiple adjustments each time the harness 100 is worn. Harness 700 can comprise mirror image fasteners 1040 on either side of harness panel 101 and harness panel 1000. In the example, a buckle attachment is illustrated for fastener 1040. It can lay flat against the animal 1 and minimize ensnarement. Alternative fasteners 1040 can comprise quick-connectors like clasps and rings and standard leash connectors. Optional features such as fasteners 1030 or hardware 1033 can be included. Many shapes and sizes of animals can be accommodated using the harness 100, 700.

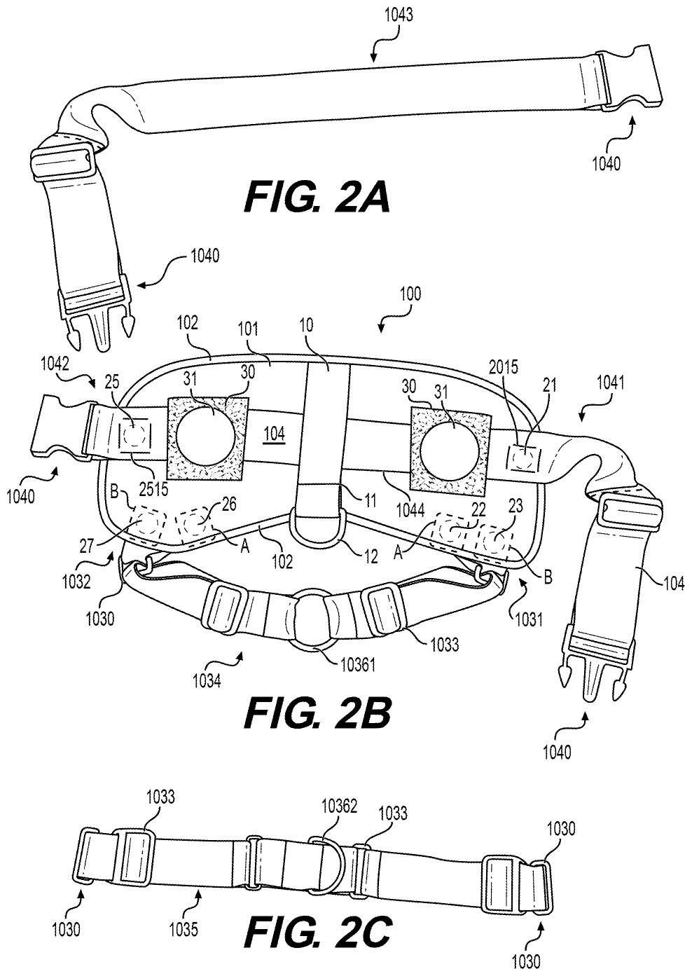

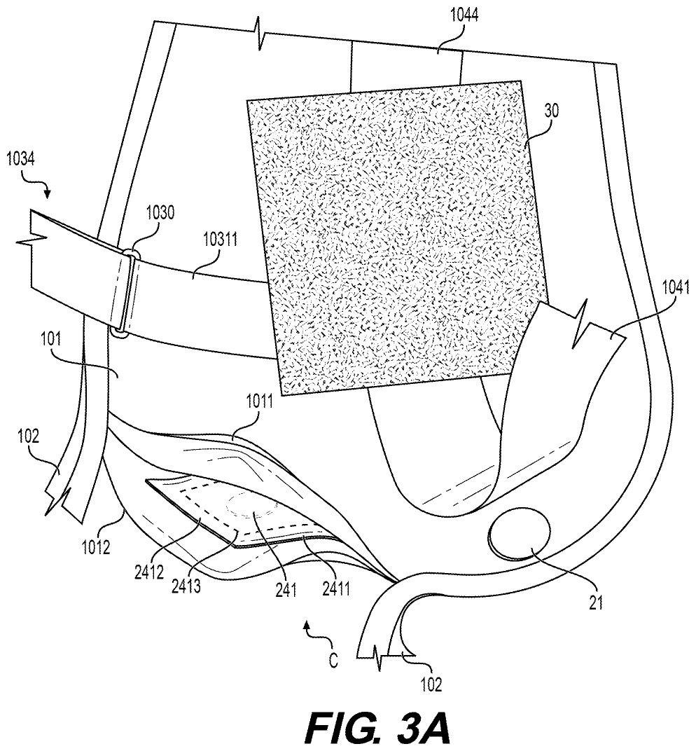

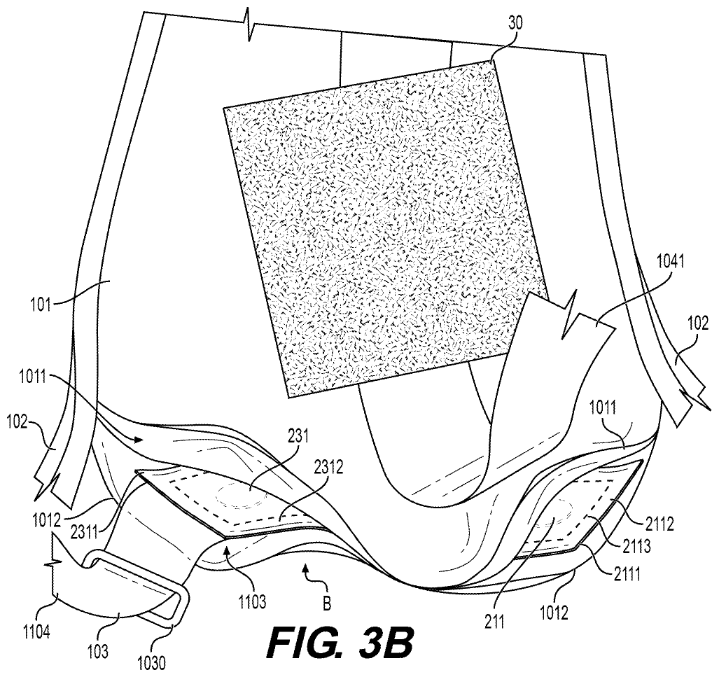

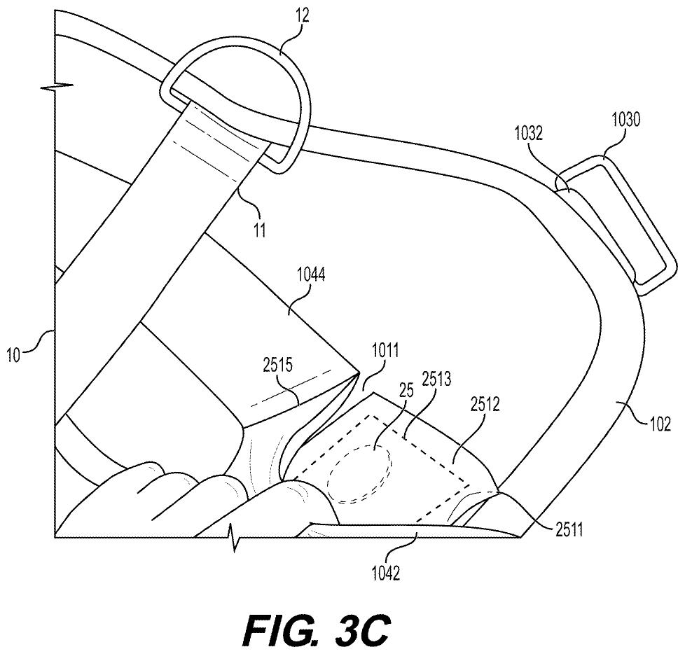

A mid-line handle 10 can be attached to seat in parallel to a spine 4 of the animal 1. The mid-line handle 10 can make it convenient to hold the animal 1 between their shoulder area thereby enhancing handling and maneuverability. Rings 12, 10361, 10362 can be used for purposes such as flexible connection of the straps, adjustability, and for anchoring a leash or other lead for the animal. The rings 12, 10361, 10362 can comprise D-rings, O-rings, or rectangular rings, or the like. The ring 12 can be secured to a sandwiched securement 13 of the handle 10 to project past the perimeter of the harness panel (FIG. 1). Or, ring 12 can comprise a securement 11 made within the perimeter of the harness panel (FIGS. 2B, 3C).

FIG. 2A shows an example of a girth expander 1043 with fasteners 1040 compatible with the girth strap 104. The harness 100, 700 can thereby grow with the animal 1, accommodate wider breeds, or be reduced in size after a pregnancy.

FIG. 2B shows the harness 100 with a first chest strap section 1034 compatible with the chest strap 103 while FIG. 2C shows an alternative chest strap section 1035. Numerous alternatives are available to aid in adjustability, pivot locations, and leash attachments. Fasteners 1030 can be used to attach the chest strap 103 and chest strap sections 1034, 1035 to the harness panel 101 or 1000. Hardware 1033 such as length adjustment features, quick disconnect clips, clasps, stays, slider buckles, keepers, tag fasteners, and pivot rings can be used along with D or O-ring leash rings 10361, 10362. Woven or braided materials can be used to form the chest strap 103 and girth strap 104. More than one piece of woven or braided material can be used to form parts of the chest strap, chest strap sections, or girth strap sections. Stitching, riveting, and heat welding are examples for securing portions of the harness 100, 700 together. Stitching, being the predominant method disclosed, can be substituted with other techniques known in the art.

A chest strap 103 could seat near or between a chest and foreleg area 2 of the animal. A girth strap 104 could wrap around the abdomen area 3. A harness panel 101 or 1000 or both can connect to the chest strap 103 and girth strap 104.

The harness panel 101, 1000 can anchor and stabilize the girth strap 104. The girth strap 104 can be stitched or otherwise secured directly to the top layer 1011 of the harness panel 101 or harness panel 1000. In FIGS. 2B, 3A, & 3B, a Velcro swatch 30 is secured to the girth strap 104 at a panel section 1044 of the girth strap 104. Panel section 1044 can go under mid-line handle 10 and under the Velcro swatch 30. This can stabilize the girth strap 104 to the harness panel 101. When sewn to the harness panel 101, Velcro swatch 30 can also form a boundary, or securement, for a magnetic element 21, 25, 211, 251 secured to the harness panel 101. Or, securements 2115, 2515 can be formed by separate stitching, welding, or riveting operations to the harness panel 101 and girth strap portions 1041, 1042.

Likewise, the harness panel 101 can anchor and stabilize the chest strap 103. The chest strap 103 can be stitched or otherwise secured directly to the top layer 1011 of the harness panel 101. In FIG. 3A, the Velcro swatch 30 is secured over ends of the chest strap portions 10311 to further stabilize the chest strap. But, in FIG. 3B, the ends of the chest strap portions 1103 & 1104 are overlaid, with the magnetic element 231 enveloped there between, and the top layer 1011 and bottom later 1012 are stitched or otherwise secured together. Chest strap portions 1031, 1032 can be secured so that the fastener 1030 projects out from the perimeter of the harness panel 101 (FIGS. 1, 2B, 3C) or the fastener 1030 can be recessed back within the perimeter of the harness panel 101 (FIG. 3A).

FIG. 1A shows a harness 100 with a single harness panel 101. FIG. 1B shows a harness 700 with two harness panels 101, 1000. The harness panels 101, 1000 can be used in the alternative or together with the girth strap 104, the chest strap 103, and the in-line handle 10. The harness panel 1000 can comprise mirror image magnetic elements 29, 30 in mirror image locations E & F. It is possible to anchor the magnetic elements 29, 30, with or without tabbed structures, in the same manner as magnetic elements 21, 25, 211, 251. The chest strap 103 can overlay the magnetic element 29 and a corresponding portion of the harness panel 1000, and the girth strap 104 can overlay the magnetic element 30 and a corresponding portion of the harness panel 1000. Cover 500, 600 can be adapted in shape to connect to locations E & F and their mirror locations to cover harness panel 1000. Should additional covering be desired, it can be possible to adapt cover 500, 600 to extend so that magnetic elements 51 & 53 or 61 & 63 magnetically connect to location E & its mirror location while magnetic elements 52 & 54 or 62 & 64 connect to location F and its mirror location. It is also possible to arrange additional magnetic elements in the cover 500 or 600 so that magnetic connection can be made to locations E, F, D, and one or more of locations A-C.

Hook and loop fastener, also called Velcro, can connect accessories 31. For example, accessories 31 can be patches for decoration, guide or support animal designations, pouches, walking lights, among others. Swatches 30 can be VELCRO, preferably the loop side, to limit ensnarement. Snaps, preferably the male side, can function as rivets, as can a FIDLOCK. Service kits, like rescue packs or courier pouches, could be attached to the harness at swatches 30 or as by including additional rings or fasteners in the panel section 1044. The cover 500, 600 can also be configured as a saddle bag or the like. One benefit of cover 500, 600 is that any optional projecting piece used for service kits or accessories can be covered up by the cover when those harness projections are not being used. The harness 100, 700 can be quickly converted to limit ensnarement hazards and to designate a service animal “at rest.” Or, a cover 500, 600 can be attached to the harness 100, 700 to provide the desired service kit attachment projections, making removal of the cover 500, 600 a quick way to remove ensnarement hazards. The in-line handle 10 can provide stability to the service kit or saddle bag so attached.

Magnetic elements 21-27, 29, 30, 211, 231, 241, 251, 51-54, 511, 521, 531, 541, 61-64 can comprise one or more magnet, steel washers, magnetic metal stampings, ferromagnetic shavings, or other magnetic materials. It is possible to place some magnets as magnetic elements 21-27, 29, 30, 211, 231, 241, 251 and some magnetic metals, like steel washers, as the other magnetic elements 51-54, 511, 521, 531, 541, 61-64, or vice versa. The harness panel 101, 1000 can comprise a mixture of magnets and magnetic metals. For example, magnets can be used at locations D or F while magnetic materials are used at locations A-C or E, or vice versa.

Magnetic elements 21-27, 29, 30, 211, 231, 241, 251 can be secured to the harness panel 101 or 1000 in similar ways. In FIG. 1, four locations are shown A-D. In FIG. 1B, 6 locations A-F are shown. Location D is for a first magnetic element 21 and a mirror location is for second magnetic element 25. Locations A-C are alternatives usable together. Location A is more proximal to a neck area of the animal, location B is enveloped in chest strap portions, and location C is more proximal to the girth of the animal 1. Each example location A-D is illustrated with a corresponding example magnetic element 21-27. Not all of the example locations A-C are required. But, the options are given for accommodating animal size, cover attachment zones, & manufacturing steps.

It is desired to anchor the corresponding magnetic elements 21, 211, 25, 251, 23, 231, 27, 29, 30 to the harness panel 101, 1000 at the same time that the girth strap 104 or chest strap 103 is anchored to the harness panel 101, 1000. This can yield efficiency in manufacture as by consolidating manufacturing steps. By anchoring the magnetic elements 21, 211, 25, 251, 23, 231, 27, 29, 30 against the harness panel 101, 1000 as disclosed, a heat and cold conduction issue is also resolved. The animal 1 receives a barrier layer between the magnetic element and its body by either the harness panel layers or the girth strap or tabbed structures.

The magnetic elements 21, 211, 25, 251, 23, 231, 27, 29, 30 can be configured so that a portion of the girth strap 104 or chest strap 103 encapsulates the magnetic element and secures the magnetic element by sandwiching the magnetic element between the harness panel 101 and the girth strap 104 or chest strap 103. The portions of the girth or chest strap 103 can form a pocket for the magnetic element thereby improving the ability to place the magnetic element relative to the harness 100 during fabrication.

FIG. 3A comprises a first example where magnetic element 21 is set against the top layer 1011 of harness panel 101. Then, girth strap portion 1041 can be laid over the magnetic element 21. Securement 2115 can comprise boundary stitching. The securement 2115 can serve the additional function of stabilizing the girth strap 104.

FIG. 3A also shows that magnetic element 241 can be enclosed in a tabbed structure 2411. A perimeter portion 2412 can comprise one or more tab for being anchored to the top layer 1011 and to the bottom layer 1012. A sheet material, such as a heat-seal plastic, fusible bonding, hem tape, fabric pocket, felting, or the like can enclose a magnetic element 241. A pocket 2413 is optionally formed. The perimeter portion 2412 can be secured (sewn, welded, or the like) with the top and bottom layer 1011, 1012. Then, a trim piece 102 can be sewn or otherwise secured around the edge to finish the edge of the harness panel 101. The trim piece 102 can add any one or more of decoration, durability, and stability. As another option, the securement of the trim piece 102 can simultaneously secure the perimeter portion of the tabbed structure 2411 with the top and bottom layers 1011, 1012.

FIG. 3B extends the tabbed structure 2311 to location B so that magnetic element 231 comprises at least one perimeter portion 2312 that can be stitched to or with the chest strap portions 1103 & 1104. Top layer 1011 and bottom layer 1012 enclose the chest strap portions 1103 & 1104 and the tabbed structure 2311. The magnetic element is very hard for the animal 1 to chew.

Also, FIG. 3B shows that the magnetic element 211 is enclosed in a pocket 2113 of tabbed structure 2111. Perimeter portion 2112 can be sewn on at least one side and possibly on all four sides to anchor the magnetic element under the girth strap 104. A first side of perimeter portion can be sewn with the top and bottom layers 1011 & 1012. The trim piece 102 can be used to secure the top and bottom layers 1011 & 1012 with the perimeter portion 2112, or the trim piece 102 can be secured in a separate step. Portions of the girth strap 104 can be stitched through at least the top layer 1011 and second and third sides of the perimeter portion 2112. Swatch 30 can optionally be secured with the girth strap and at least the top layer 1011 with a fourth side of the perimeter portion 2112. If the tabbed structure is circular or other shapes, then first through fourth zones can be secured like the sides described above. The bottom layer 1012 can be secure to the tabbed structure instead of or in addition to the top layer 1011.

In FIG. 3C, the tabbed structure 2511 is placed on top of the top layer 1011 and underneath the girth strap 104. The magnetic element 25 in the pocket 2513 can be similarly secured by the tabbed structure 2512 as above for magnetic element 211.

The animal 1 cannot easily chew the magnetic elements 21, 211, 25, 251, 23, 231, 27, 29, 30 as they do not jut out or dangle. The girth strap portions 1041, 1042, the top layer 1011, and the bottom layer 1012 can pad against chewing. When configured in location B, the chest strap portions 1031, 1032 protect against chewing. When either or both of locations A & C are used, the top layer 1011, the bottom layer 1012 and the tabbed structures 2211, 2411, etc. can provide protection from chewing. The harness panel 1000 and girth strap 103 or chest strap 103 offer protection against chewing at locations E & F. The magnetic elements are less prone to wearing through the harness 100, as their locations tuck them out of high-contact areas of the harness. The tabbed structures 2111, 2311, 2411, 2511, etc. provide an additional boundary to the animal's access to the magnetic elements. And, the tabbed structures can provide a manufacturing expedient as by improving the handling of the magnetic elements.

One or more trim piece 102, sometimes called binding, can be included around the perimeter of the harness panel 101 or 1000 to finish the edge of the harness panel 101, 1000. The magnetic elements 21-27, 29, 30, 211, 231, 241, 251, etc. can be secured to the harness 100, 700 so that they do not overlap or interfere with the trim piece. The trim piece 102 can receive wear and tear while the magnetic elements 21-27, 29, 30, 211, 231, 241, 251, etc. are recessed from the trim piece 102.

The cover 500 can comprise a decorative cover or top wall 501 (also called a “top sheet”) that faces the viewer and a back wall 502 (also called a “back wall sheet”) that faces the harness 100, 700. The cover 500 can thread under the mid-line handle 10 and can magnetically secure to the magnetic elements 21-27, 211, 231, 241, 251, etc. embedded in the harness 100. Magnetic elements 51-54 can be secured to various locations of the cover 500. In a first example, the magnetic elements 51-54 are secured to the top wall 501 at extrema of the cover 500. Four harness locations A-D for the harness magnetic elements 21-27, 211, 231, 241, 251, etc. can be paired with four cover locations of the cover magnetic elements 51-54. Two pairings of magnetic elements (for example, at mirror girth strap locations D) can be used. Or, four pairings can be used (one of locations A-C in mirror image plus location D). Or, additional pairings can be used (for example, locations A & C in mirror image plus location D).

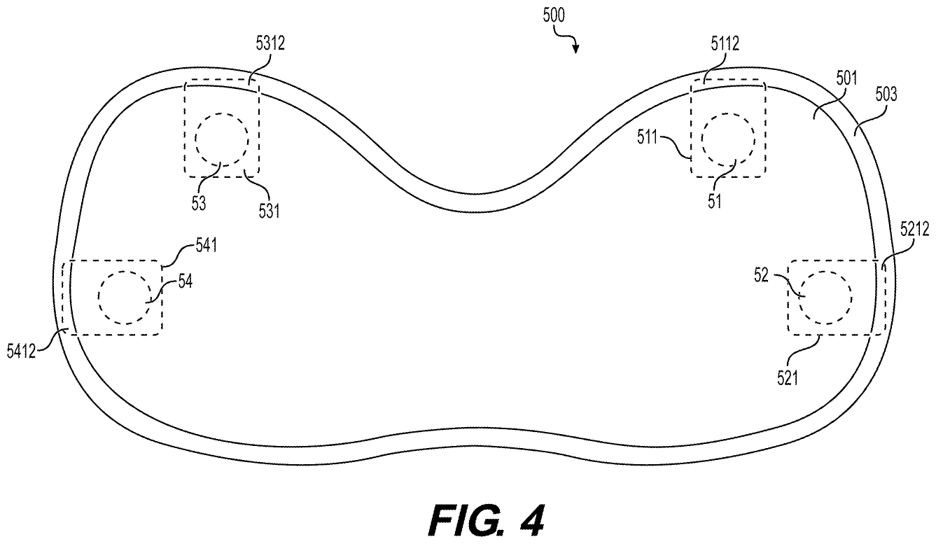

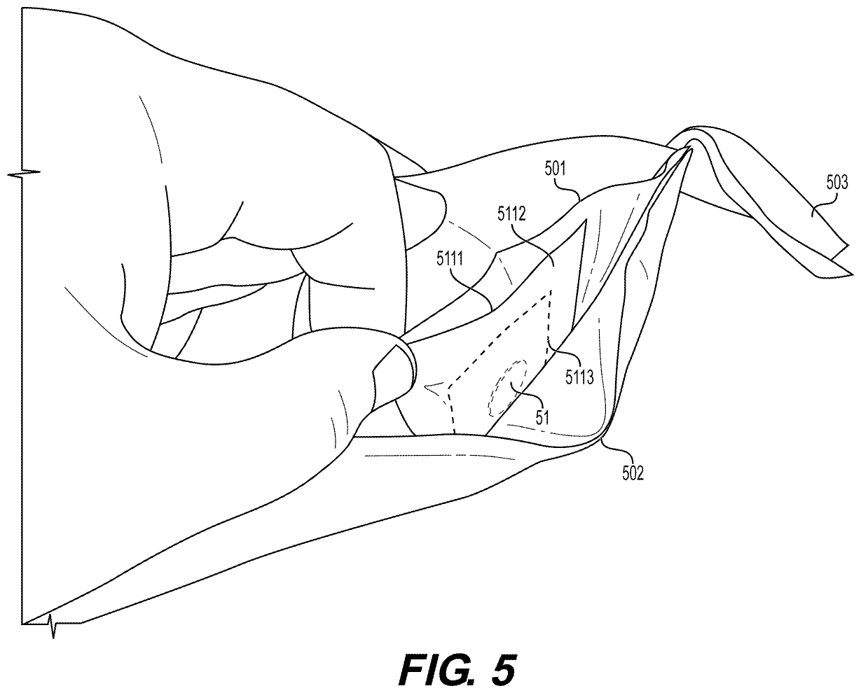

FIGS. 4 & 5 illustrate that tabbed structures 511, 521, 531, 541 enclose the magnetic elements 51-54. Corresponding perimeter portions 5112 can be sewn or otherwise secured with the top wall 501 and the bottom wall 502 at the perimeter. A cover trim piece, also called a binding piece 503, can encircle the perimeter of the cover 500. The binding piece 503 can be sewn with or after the top wall 501 and bottom wall 502 are sewn with the perimeter portions 5112. Magnetic elements 51-54 can have some play in the pocket 5113 of the tabbed structure for alignment with the harness magnetic elements (which likewise can have play in their corresponding pockets 2113, 2413, 2513, etc.).

Or, the magnetic elements 51-54 can be secured to or in an inner third layer that is between the top wall 501 and the back wall 502. The magnetic elements 51-54 can be embedded in a patch, a packet, or tabbed structure 5111 that provides one or more edge (perimeter portion 5112) for sewing or affixing the magnetic element 51-54 within the cover 500. The inner third layer can comprise an insulation material such as felt, or batting, or a lighter material such as mesh, or lining material, or a stiffener or a structural support material such as cardboard or backing. Layers of material can be sewn to form multiple pockets for the magnetic elements 51-54, thereby forming alternative tabbed structures. Such an alternative third inner layer can be used in the harness 100, 700 or cover 500, 600 so that the tabbed structures are part of a larger sheet material, thereby integrating the 2, 4 or more magnetic elements into a stabilized form.

An edge can be sewn at a trim portion of the cover 500 and the binding piece 503 can cover this edge. The magnetic elements 51-54 can project away from the binding piece 503 and between the top wall 501 and the back wall 502. Or, the perimeter piece 5112 etc. of the magnetic element 5111 etc. can be sewn to the top 501 before the top wall 501 is affixed to the back wall 502. The magnetic element 51-54 can be distanced from the binding piece 503 of the cover 500 so that the binding piece 503 takes the wear and tear while the magnetic element does not wear through the cover 500. This is a departure from the prior art that places ensnarements at the perimeter of harnesses and harness accessories, where wear and tear is applied. These prior art options make it too easy for the animal to chew the ensnarements.

The cover 500 can also shaped to fit under the in-line handle 10. Then, the in-line handle 10 can be used to hold the cover 500 in place. Yet, the cover 500 is easily slipped under the in-line handle 10 for securement. This is unlike alternatives in the art that require the user to lace straps through pockets to exchange covers with a harness. The magnetic element combinations are much easier than snaps or buttons to engage. With appropriate pole-positioning of the magnetic elements, self-sticking can be eliminated or reduced to enable a great advantage over snap or Velcro-trimmed prior art combinations. Not to mention, noise, pinching, pulling, and confinement are reduced over the prior art.

Corresponding adjustments can be made to connect magnetic elements 51-54 of cover 500 to magnetic elements 29, 30 of harness panel 1000.

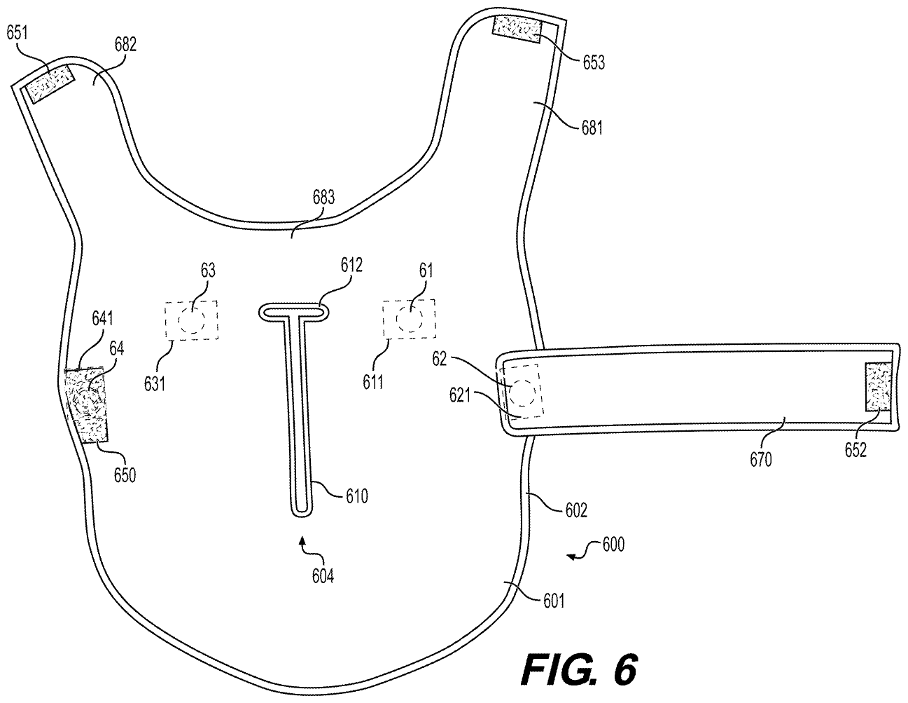

Turning to FIG. 6, a cover 600 is shown with portions that extend beyond the harness panel. Such a cover 600 can function as a rain or wind jacket or coat. Cover 600 can also accommodate service kits or saddle bag type configurations. Chest strap extension 681-683 can provide protection to a neck and shoulder area of an animal 1. Chest strap extensions 681, 682 can optionally comprise magnetic elements to connect at mirror locations E. Velcro tabs 651, 653 or additional magnetic elements can join two of the chest strap extension 681, 682 around the chest strap section 1034, 1035. A girth strap cover 670 can enclose the girth strap 104. Girth Velcro tabs 650, 652 can connect to stabilize the girth strap cover 670 among other options such as additional magnetic elements to connect at mirror locations F. But, similar to the above swatches 30, the Velcro tab 650 can be used to stabilize the magnetic element 64 by either bounding the magnetic element 64 to or between layers of the cover 600, or as by aligning its boundaries with one to four perimeter portions or zones of a tabbed structure 641. Likewise, girth strap cover 670 can be sewn so that it bounds a magnetic element 62 at the same time that it is secured to the cover 600. Either the girth strap cover 670 can be sewn down to bound the magnetic element 62 to or between layers of cover 600, or a tabbed structure 621 can be sewn with the girth strap cover.

A binding piece 602 can be included on the cover 600. Binding piece 602 can function similarly as trim piece 102 and binding piece 503 for magnetic elements 62 & 64 and optional additional magnetic elements of the chest strap extensions 681- 682. Also, at least a leash ring slit or leash ring pass-through 612 can be included in a middle portion 604 of the cover 600 to pass the leash ring 12 through the cover 600. Or, an optional handle slit or handle pass-through 610 can be formed with the leash ring pass through 612 so that the handle can protrude through the cover 600. When leash rings or handles are included on harness panel 1000, like pass-throughs can be formed in the cover 500 adapted for use therewith. In the embodiment of FIG. 6, the cover 600 is not stabilized by passing under the in-line handle 10. However, the in-line handle 10 optionally projecting through the cover 600 can offer stability to the placement of the cover 600.

The harness 100, 700 and cover 500, 600 can comprise washable materials. The material selection for the harness 100, 700 and cover 500, 600 can be selected for durability, decoration, among other uses. Unlike the prior art, a single harness 100, 700 can be used with multiple covers 500, 600 providing significant cost and storage/space savings. Many alternatives are possible, including fabric type (rainwear, insulation, cooling, calming, weighting, reflective, fluorescent, wicking, air mesh, CORDURA, holiday, season, mascot, etc.), alternative strap connections (buckles, clips, etc.), and accessories such as lights, cooling rings, insect repellents, Velcro pouches, and patches.

Other implementations will be apparent to those skilled in the art from consideration of the specification and practice of the examples disclosed herein.

What is claimed is:

1. A harness for an animal, comprising:
a chest strap configured to seat near a neck and a foreleg area of the animal, the chest strap comprising a first chest strap portion and a second chest strap portion;
a girth strap configured to wrap around an abdomen of the animal, the girth strap comprising a first girth strap portion and a second girth strap portion;
a harness panel connected to the first chest strap portion, the second chest strap portion, the first girth strap portion, and the second girth strap portion;
a first magnetic element embedded under the first girth strap portion; and
a second magnetic element embedded under the second girth strap portion.

2. The harness of claim 1, further comprising at least a third magnetic element embedded under or adjacent the first chest strap portion and at least a fourth magnetic element embedded under or adjacent the second chest strap portion.

3. The harness of claim 1, wherein, when included, one or more of the first magnetic element, the second magnetic element, the third magnetic element, and the fourth magnetic element is enclosed in a respective tabbed structure and is secured to the harness panel by way of the respective tabbed structure.

4. The harness of claim 1, wherein, when included, one or more of the first magnetic element, the second magnetic element, the third magnetic element, and the fourth magnetic element is flush against an exterior of a top layer of the harness panel.

5. The harness of claim 1, wherein, when included, one or more of the first magnetic element, the second magnetic element, the third magnetic element, and the fourth magnetic element is enclosed between a top layer and a bottom layer of the harness panel.

6. The harness of claim 5, wherein:
the harness panel comprises:
a top layer;
a bottom layer; and
a trim piece,
when included, the first magnetic element, the second magnetic element, the third magnetic element, and the fourth magnetic element is enclosed in a respective tabbed structure, and
wherein at least one or all of the first magnetic element, the second magnetic element, the third magnetic element, and the fourth magnetic element is joined together with the top layer, the bottom layer, and the trim piece by the respective tabbed structure.

7. The harness of claim 1, further comprising a mid-line handle attached to the harness panel, the mid-line handle configured to parallel a spine of the animal.

8. The harness of claim 1, wherein the first girth strap portion encapsulates the first magnetic element, and whereby the first magnetic element is attached to the harness panel.

9. The harness of claim 2, wherein the first chest strap portion encapsulates the first magnetic element, and whereby the encapsulated first magnetic element is attached to the harness panel.

10. The harness of claim 1, wherein the harness panel further comprises a trim piece encircling a perimeter of the harness panel, and wherein the trim piece does not overlap with the first magnetic element or the second magnetic element.

11. A cover for an animal harness, the animal harness comprising at least one harness panel, the cover comprising:
a back wall sheet shaped to cover the harness panel;
a top sheet shaped to cover the back wall sheet;
a binding piece securing the back wall sheet and the top sheet to form a perimeter cover edge; and
a first cover magnetic element secured between the top sheet and the back wall sheet; and
a second cover magnetic element secured between the top sheet and the back wall sheet.

12. The cover of claim 11, wherein the first cover magnetic element is encapsulated in a tabbed structure, and wherein the first cover magnetic element is secured in place by stitching the tabbed structure together with a portion of the top sheet, and a portion of the back wall sheet.

13. The cover of claim 12, wherein the tabbed structure is further stitched together with a portion of the binding piece.

14. The cover of claim 11, wherein the first cover magnetic element is encapsulated in a tabbed structure, and wherein the first cover magnetic element is secured in place by stitching the tabbed structure to the top sheet.

15. The cover of claim 11, wherein the first cover magnetic element does not overlap with the binding piece.

16. The cover of claim 11, wherein the first cover magnetic element is encapsulated in a tabbed structure, and wherein the cover comprises an inner layer between the back wall sheet and the top sheet, and wherein the first cover magnetic element is secured to the inner layer.

17. The cover of claim 11, further comprising a middle portion comprising a leash ring pass-through, the leash ring pass-through passing through the top sheet and through the back wall sheet.

18. The cover of claim 11, further comprising a girth strap cover configured to overlay the girth strap and at least one chest strap extension configured to overlay a portion of the chest strap.

19. The cover of claim 11, wherein the first cover magnetic element and the second cover magnetic element are configured to secure at a shoulder area of the animal or at a chest area of the animal.

20. The cover of claim 11, wherein the first cover magnetic element and the second cover magnetic element are configured to secure at a girth area of the animal.

21. The cover of claim 11, wherein the first cover magnetic element is configured to secure at a shoulder area of the animal and wherein the second cover magnetic element is configured to secure at a girth area of the animal.

22. The cover of claim 11, configured to seat under a mid-line handle of the harness, the mid-line handle configured to parallel a spine of the animal.

23. A covered harness for an animal, comprising:
a harness, comprising:
a chest strap configured to seat between a chest and a foreleg area of the animal, the chest strap comprising a first chest strap portion and a second chest strap portion;
a girth strap configured to wrap around an abdomen of the animal, the girth strap comprising a first girth strap portion and a second girth strap portion;
a harness panel connected to the first chest strap portion, the second chest strap portion, the first girth strap portion, and the second girth strap portion;
a first magnetic element embedded under the first girth strap portion; and
a second magnetic element embedded under the second girth strap portion; and
a cover, comprising:
a back wall sheet shaped to cover the harness panel;
a top sheet shaped to cover the back wall sheet;
a binding piece securing the back wall sheet and the top sheet to form a perimeter cover edge; and
a first cover magnetic element secured between the top sheet and the back wall sheet, wherein the first cover magnetic element magnetically connects to the first magnetic element; and
a second cover magnetic element secured between the top sheet and the back wall sheet, wherein the second cover magnetic element magnetically connects to the second magnetic element.

24. The covered harness of claim 22, further comprising:
a third magnetic element embedded under or adjacent the first chest strap portion;
a fourth magnetic element embedded under or adjacent the second chest strap portion;
a third cover magnetic element secured between the top sheet and the back wall sheet, wherein the third cover magnetic element magnetically connects to the third magnetic element; and
a fourth cover magnetic element secured between the top sheet and the back wall sheet, wherein the fourth cover magnetic element magnetically connects to the fourth magnetic element.
